(19) United States
(12) Patent Application Publication
(10) Pub. No.: US 2024/0083595 A1
(43) Pub. Date: Mar. 14, 2024

(54) LANDING GUIDE SYSTEM USING ENERGY ANALYSIS OF UAM AIR VEHICLE

(71) Applicant: RUDA SYS Co., Ltd., Incheon (KR)

(72) Inventors: Jin Ho KIM, Gwacheon-si (KR); Jl Hwan KIM, Seoul (KR); Woo Choon MOON, Gimpo-si (KR)

(73) Assignee: RUDA SYS Co., Ltd., Incheon (KR)

(21) Appl. No.: 17/945,088

(22) Filed: Sep. 15, 2022

(30) Foreign Application Priority Data
Sep. 14, 2022 (KR) 10-2022-0115927

(51) Int. Cl. B64D 45/04; B64C 39/02; G08G 5/02

(52) U.S. Cl. CPC B64D 45/04; B64C 39/024; G08G 5/025; B64C 2201/146

(57) ABSTRACT

A landing guide system using an energy analysis of a UAM air vehicle is disclosed. A UAM air vehicle consists of a UAM air vehicle landing guide device for guiding a landing by analyzing a movement of the UAM air vehicle in a descent and approach section of the UAM air vehicle to a vertiport, and a remote control terminal that monitors the descent and approach section of the UAM air vehicle in real time through the UAM air vehicle landing guide device. The UAM air vehicle is configured to output a warning for safe descent and access according to a predetermined standard in accordance with the guide of the above UAM air vehicle landing guide device in the descent and approach section. The landing guide system using the energy analysis of the UAM air vehicle described above is configured to calculate the flight dynamics energy of the UAM air vehicle attempting to land at the vertiport in real time and determine whether the calculated energy is in the appropriate energy section according to the location, thereby making it possible to determine whether the UAM air vehicle is attempting to land stably. Meanwhile, if it is determined that the energy of the UAM air vehicle belongs to the attention or warning energy section, this is immediately notified to the UAM air vehicle, thereby obtaining the effect of guiding the UAM air vehicle to safely land.

### CROSS-REFERENCE TO RELATED APPLICATIONS

This application claims priority to and the benefit of Korean Patent Application No. 10-2022-0115927 filed in the Korean Intellectual Property Office on 14 Sep. 2022, the entire contents of which are incorporated herein by reference.

### TECHNICAL FIELD

The present invention relates to a landing guide system of air vehicle, specifically a landing guide system using an analysis of a flight motion energy of a UAM (urban air mobility) air vehicle.

### BACKGROUND ART

The Urban air mobility (UAM) is expected to be a means of moving quickly without a traffic congestion, either within the city center or between cities. And, there is advantage that the vertiport, where the UAM air vehicle can take off and land, is able to be installed as many times as possible on the roof of buildings in the complex city center. In the future, it is expected that passengers can easily board and move from the vertiport of numerical short distances in the city center.

However, the UAM air vehicle are still greatly influenced by strong winds and weather conditions, and the vertiport is also not properly studied for a safe device for safely landing.

In the case of airports, a separate control tower can be installed and operated; however, since the vertiport is installed in a narrow space in the city center, there is no enough space to install a separate control tower, and the cost of operating navigation safety facilities is also excessive per each vertiport. Furthermore, there may be a problem of a strong exposure to electromagnetic waves in the city. Accordingly, it can be seen as impossible to install a control tower for all vertiports.

In this situation, a pilot will have to land the UAM air vehicle by relying solely on his senses. Also, the pilot may believe that there are inevitably many vertiports of landing for the first time, and repeating a landing without a safety device will inevitably increase the risk of accidents.

Accordingly, a request for development of landing guidance (guide) devices optimized for the UAM air vehicle that can safely land without a control tower in many vertiports in the city center is rising.

### SUMMARY OF THE INVENTION

The object of the present invention is to provide a landing guide system using an energy analysis of a UAM air vehicle.

The landing guide system using the energy analysis of the UAM air vehicle according to the object of the present invention as stated above may be constructed to include a UAM air vehicle, as well as a landing guide device that would guide landing by analyzing the movement of the UAM air vehicle in a descent and approach section of the UAM air vehicle to a vertiport.

Here, it may be configured to further include a remote control terminal for a real-time monitoring of the descent and approach section of the UAM air vehicle through the UAM air vehicle landing guide device

In addition, the UAM air vehicle may be configured to output a warning for safe descent and access according to a predetermined standard in the descent and approach section according to the guide of the UAM air vehicle landing guide device.

The landing guide system using the energy analysis of the UAM air vehicle as stated above is configured to calculate the flight dynamics energy of the UAM air vehicle attempting to land at the vertiport in real time and determine whether the calculated energy is in the appropriate energy section according to the location, thereby obtaining the effect to determine whether the UAM air vehicle is attempting to land stably.

In particular, it is configured to easily calculate an energy only with the altitude and speed of the UAM air vehicle through an image, a microwave detector, and a LRF device, thereby obtaining the effect of quickly determining a stability of landing.

Meanwhile, if it is determined that the energy of the UAM air vehicle belongs to an attention or warning energy section, it is immediately notified to the UAM air vehicle, thereby obtaining the effect of inducing the UAM air vehicle to land safely.

In particular, if it is determined that the energy of the UAM air vehicle belongs to the attention or warning energy section, it is configured to use the real-time energy of the UAM air vehicle to inversely calculate the appropriate altitude and speed and provide it to the UAM air vehicle in real-time, thereby obtaining the effect of guiding the UAM air vehicle to a stable landing by adjusting the altitude and speed at every moment during landing.

Meanwhile, it is constructed to generate a learning model using various data on the landing processes of the UAM air vehicle, use it for a deep reinforcement learning, and also derive a safe energy section during the landing process, thereby obtaining the effect of securing guidelines for a safe landing in consideration of various factors influencing the landing process of the UAM air vehicle.

On the other hand, it is constructed to differently set only the color of the lighting for inducing a safe approach angle among the lights provided on each side of the cube-shaped structure so as to ensure a safe descent of the pilot by visually checking the color of the light for a safe access.

### BRIEF DESCRIPTION OF THE DRAWINGS

FIGS. 1A and 1B are block diagrams of a landing guide system using an energy analysis of a UAM air vehicle according to an embodiment of the present invention.

FIG. 2 is a schematic diagram of a descent and an approach section according to an embodiment of the present invention.

FIG. 3 is a graph illustrating an appropriate energy section of a UAM air vehicle upon descent and approach according to the present invention.

FIG. 4 is an exemplary diagram illustrating a shape of a safe approach slope guide device according to an embodiment of the present invention.

### DETAILED DESCRIPTION

The present invention may apply various changes and have various embodiments, and thus, specific embodiments will be illustrated in the drawings and described in detail for implementing the invention. However, this is not intended to limit the present invention to specific embodiments, and should be understood to include all changes, equivalents or substitutes included in the idea and technical scope of the present invention. While explaining each drawing, similar reference numerals were used for similar components.

The terms such as first, second, A, B, and the like may be used to explain various components, but the components should not be limited by the terms. The terms are used only for the purpose of distinguishing one component from another component. For example, without deviating from the right scope of the present invention, a first component may be referred to as a second component, and similarly, a second component may also be referred to as a first component. The term such as and/or includes a combination of a plurality of items of related descriptions or any one of a plurality of items.

When it is referred that any component is “connected” or “accessed” to another component, it may be directly connected to or accessed to another component, but it should be understood that another component may exist in the middle. Meanwhile, when it is referred that any component is “directly connected” or “directly accessed” to another component, it should be understood that no other component exists in the middle.

The terms used in the present application are used only to describe specific embodiments and are not intended to limit the present invention. Singular expressions include plural expressions unless the context clearly means something else. In the present application, it should be understood that the term “include” or “have” is intended to designate the presence of features, numbers, steps, operations, components, parts, or a combination thereof described in the specification, and it does not preclude the possibility of the presence or addition of one or more other features or numbers, steps, operations, components, parts, or combinations thereof.

Unless otherwise defined, all terms used herein, including technical or scientific terms, have the same meaning as those generally understood by a person skilled in the art to which the present invention pertains. The terms such as those defined in commonly used dictionaries shall be interpreted as having a meaning consistent with the meaning of the relevant technology and shall not be interpreted as ideal or overly formal unless clearly defined in this application.

Hereinafter, the preferred embodiments according to the present invention will be described in detail with reference to the accompanying drawings.

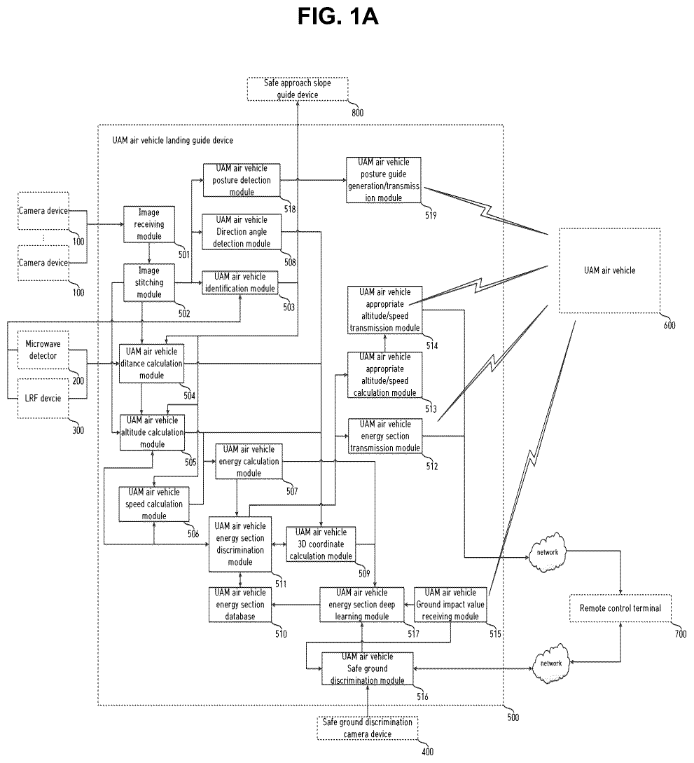

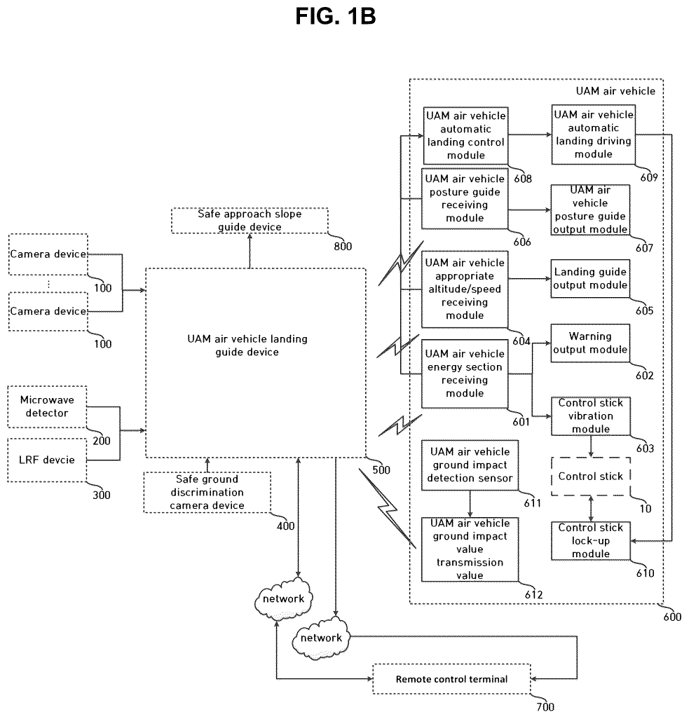

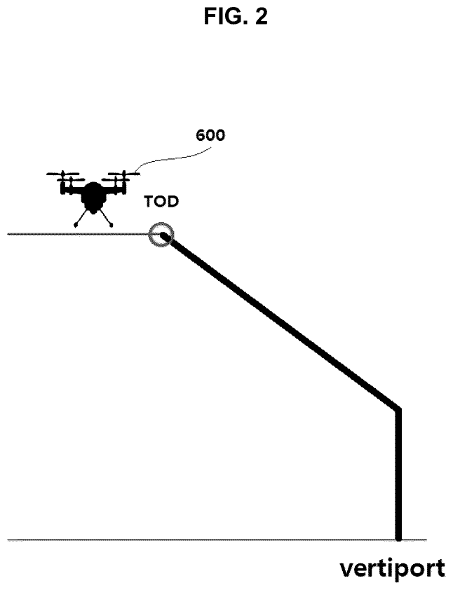

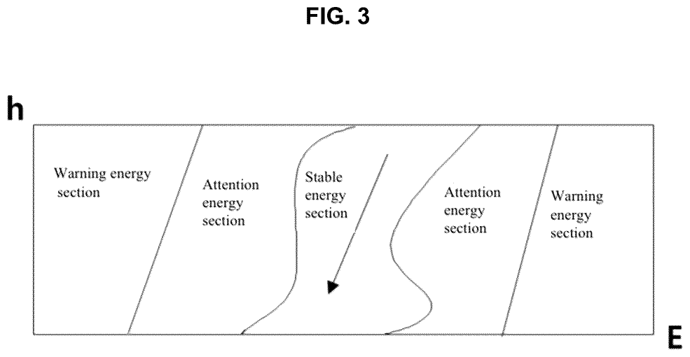

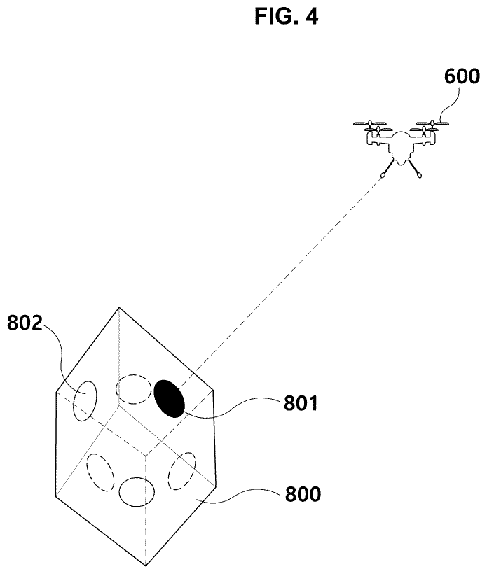

FIGS. 1A and 1B are block diagrams of a landing guide system using an energy analysis of a UAM air vehicle according to an embodiment of the present invention. And, FIG. 2 is a schematic diagram of a descent and approach section according to an embodiment of the present invention, FIG. 3 is a graph showing an appropriate energy section of a UAM air vehicle during descent and approach according to the present invention, and FIG. 4 is an exemplary diagram illustrating a shape of a safe approach slope guide device according to an embodiment of the present invention.

Firstly, referring to FIGS. 1A and 1B, the landing guide system using an energy analysis of a Urban Air Mobility (UAM) air vehicle according to an embodiment of the present invention may be configured to include a camera device (100), a microwave detector (200), a LRF (laser range finder) device (300), a safety ground discrimination camera device (400), a UAM air vehicle landing guide device (500), and a UAM air vehicle (600).

Hereinafter, a detailed configuration will be described.

A plurality of camera devices (100) may be installed in the vertiport.

The camera device (100) may be configured to generate an image by photographing the UAM air vehicle (600) that attempts to land on the vertiport. The distance and position of the UAM air vehicle (600) may be calculated using the image of the camera device (100).

The microwave detector (200) may be installed in the vertiport. The microwave detector (200) may be configured to radiate microwaves and receive microwaves reflected from the UAM air vehicle (600). The distance and position of the UAM air vehicle (600) may be calculated using the microwave detector (200).

The LRF device (300) may be installed in the vertiport.

The LRF device (300) may be configured to radiate a laser signal and receive a laser signal reflected from the UAM air vehicle (600). The distance of the UAM air vehicle (600) may be calculated using the LRF device (300).

The safety ground discrimination camera device (400) may be configured to photograph a ground process of the UAM air vehicle (600) in order to determine whether the UAM air vehicle (600) is safely grounded.

The UAM air vehicle landing guide device (500) is the configuration to guide a safe landing of the UAM air vehicle (600).

Firstly, the UAM air vehicle landing guide device (500) may be configured to calculate the distance and position of the UAM air vehicle (600) using a number of camera devices (100), microwave detectors (200), and LRRF devices (300).

In addition, the UAM air vehicle landing guide device (500) may be configured to guide landing by analyzing the flight dynamics energy of the UAM air vehicle (600) in the descent and approach section of the UAM air vehicle (600) using the calculated distance and position above.

Here, as shown in FIG. 2, the descent and approach section means the section from the TOD (top of descent) point to the ground at the vertiport. The UAM air vehicle (600) descends and approaches at the TOD point through the downhill section. As shown in FIG. 2, the landing process of the UAM air vehicle (600) may be performed by means of descending along an approach slope at an inclined angle, descending vertically at an appropriate altitude, and grounding to the vertiport.

At this time, if the UAM air vehicle (600) descends too fast or the angle of the approach slope is not appropriate, it may collide with the vertiport or fall to the ground. Therefore, the UAM air vehicle landing guide device (500) should quickly and accurately determine whether the UAM air vehicle (600) is landing safely, and if it is not landing safely, it should be known as the UAM air vehicle (600) to guide a safe landing.

The UAM air vehicle landing guide device (500) may be configured to calculate and determine the flight dynamics energy of the UAM air vehicle (600) in real time for determining a safe landing process. As simply reviewing, if the flight dynamics energy of the UAM air vehicle (600) belongs to the safe energy section of FIG. 3, it may be determined that the energy of FIG. 3 belongs to the attention energy section or the warning energy section, it may be determined that the flight dynamics energy of the UAM air vehicle (600) is stably landing.

The UAM air vehicle (600) may be configured to output a warning for safe descent and access according to a predetermined standard according to the guide of the UAM air vehicle landing guide device (500) in the descent and approach section.

The remote control terminal (700) may be configured to monitor the descent and approach section of the UAM air vehicle (600) in real time through the UAM air vehicle landing guide device (500). The remote control terminal (700) may be configured to monitor a plurality of vertiports in real time.

The safe approach slope guide device (800) may be configured to guide the approach slope of the UAM air vehicle (600) from the TOD (top of descent) so that the pilot of the UAM air vehicle (600) can visually check it.

Referring to FIG. 4, the safe approach slope guide device (800) can be configured to include a safe approach slope light (801) and an unsafe approach slope light (802).

As shown in FIG. 4, the safe approach slope guide device (800) may have a cube-shaped lighting structure, the safe approach slope light (801) may be provided on one side of the cube-shaped lighting structure, and the unsafe approach slope light (802) may be provided on the other side.

Here, the safe approach slope light (801) and the unsafe approach slope light (802) may be configured with the lights of different colors. For example, the safe approach slope light (801) may be a red light, and the unsafe approach slope light (802) may be a blue light.

Furthermore, the safe approach slope light (801) may be configured to face at the same angle as the access slope. If only the red light of the safe approach slope light (801) is visible to the pilot's naked eye while the UAM air vehicle (600) is descending and approaching at a gentle slope, it can be seen as a stable approach slope; likewise, if the blue of the unsafe approach slope light (802) is also visible, it can be seen as a slight departure from the safe approach slope. Even if there is no separate means, the pilot can virtually detect the safe approach slope to find the angle of descent.

The UAM air vehicle landing guide device (500) is configured to comprise an image receiving module (501), an image stitching module (502), a UAM air vehicle identification module (503), a UAM air vehicle distance calculation module (504), a UAM air vehicle altitude calculation module (505), a UAM air vehicle speed calculation module (506), a UAM air vehicle energy calculation module (507), a UAM air vehicle direction angle detection module (508), a UAM air vehicle 3D coordinate calculation module (509), a UAM air vehicle energy section database (510), a UAM air vehicle energy section discrimination module (511), a UAM air vehicle energy section transmission module (512), a UAM air vehicle appropriate altitude/speed calculation module (513), a UAM air vehicle appropriate altitude/speed transmission module (514), a UAM air vehicle ground impact value receiving module (515), a UAM air vehicle safe ground discrimination module (516), a UAM air vehicle energy section deep learning module (517), a UAM air vehicle posture detection module (518), a UAM air vehicle posture guide generation/transmission module (519).

Hereinafter, a detailed configuration will be described.

The image receiving module (501) may be configured to receive images generated by a plurality of camera devices (100).

The image stitching module (502) may be configured to generate a panorama image in real time by stitching the image received from the image receiving module (501). The image stitching module (502) may generate an omnidirectional panorama image as well as obtain a larger image as the number of camera devices (100) increases.

The UAM air vehicle identification module (503) may be configured to identify the UAM air vehicle (600) that is intended to descend and approach to the vertiport using a panoramic image generated by the image stitching module (502), a microwave received from the microwave detector (200), and a laser signal received from the LRF device (300).

The UAM air vehicle identification module (503) may confirm and identify the identity of the UAM air vehicle (600) detected by the image stitching module (502), the microwave detector (200), or the LRF device (300), respectively.

The UAM air vehicle distance calculation module (504) may be configured to calculate the distance from the UAM air vehicle (600) identified by the UAM air vehicle identification module (503) in real time using an image generated by a number of camera devices (100), a microwave received by the microwave detector (200), and a laser signal received from the LRF device (300), respectively.

Here, the UAM air vehicle distance calculation module (504) may calculate the distance to the corresponding UAM air vehicle (600) using a triangulation method using images of two camera devices (100) installed at distances spaced apart from each other. In addition, the UAM air vehicle distance calculation module (504) may calculate the distance to the corresponding UAM air vehicle (600) using the reception time of the microwave and the reception time of the laser signal, respectively.

The UAM air vehicle distance calculation module (504) may be configured to calculate the distance using the distance calculated by each of these three means, or to calculate the distance by any one of the means determined to be accurate. For example, the UAM air vehicle distance calculation module (504) may calculate a distance by selecting a means having high accuracy of measurement for each distance section. There is no limit to the method or algorithm of distance calculation.

UAM air vehicle altitude calculation module (505) may be configured to calculate the altitude of the UAM air vehicle (600) identified by the UAM air vehicle identification module (503) in real time using an image generated by a plurality of camera devices (100) and a microwave received by the microwave detector (200), respectively.

Here, the UAM air vehicle distance calculation module (504) may calculate an altitude to the corresponding UAM air vehicle (600) using a triangulation method using images of two camera devices (100) installed at distances spaced apart from each other. In addition, the UAM air vehicle distance calculation module (504) may calculate the altitude of the UAM air vehicle (600) using the reception time and the irradiation angle of the microwave, respectively.

The UAM air vehicle speed calculation module (506) may be configured to calculate the speed of the UAM air vehicle (600) identified in the UAM air vehicle identification module (503) in real time by grasping the time change in the distance from the UAM air vehicle distance calculation module (504)) to the UAM air vehicle (600) calculated in real time.

The UAM air vehicle energy calculation module (507) may be configured to calculate the energy of the UAM air vehicle (600) in real time using the altitude calculated by the UAM air vehicle altitude calculation module (505) and the speed calculated by the UAM air vehicle speed calculation module (506).

Here, the UAM air vehicle energy calculation module (507) may be configured to calculate an energy of the UAM air vehicle (600) according to Equation 1.

$${E}_{h} = \frac{{V}^{2}}{2 g} + h \qquad [ Equation 1 ]$$

Here, Eₕ is the energy of the UAM air vehicle (600), V is the speed of the UAM air vehicle (600), h is the altitude of the UAM air vehicle (600), and g is the gravitational acceleration.

The energy Eₕ of the UAM air vehicle (600) may be defined as the sum of specific kinetic energy and potential energy except for mass.

In this way, it is possible to ignore the mass and calculate the energy Eₕ in the energy formula of the UAM air vehicle (600) because most models of the UAM air vehicle (600) are small enough to accommodate 4-5 people, and the number of passengers is within 4-5, so there is not much difference in mass between the air vehicles. Meanwhile, in the case of airplanes, it varies from light airplane o large airplane, and the mass of the air vehicle varies in a large range depending on the number of passengers. Accordingly, the energy formula of the air vehicle according to Equation 1 can be applied.

That is, regardless of the model of the UAM air vehicle (600), a stability during the descent and approach of the UAM air vehicle (600) can be determined using the energy Eₕ of the UAM air vehicle (600).

The UAM air vehicle direction angle detection module (508) may be configured to detect the direction angle of the UAM air vehicle (600) in real time using a panorama image generated in real time by the image stitching module (502).

The UAM air vehicle 3D coordinate calculation module (509) may be configured to calculate the three-dimensional coordinates of the UAM air vehicle (600) in real time by using the distance to the UAM air vehicle (600) calculated in the UAM air vehicle distance calculation module (504), the altitude calculated in the UAM air vehicle altitude calculation module (505), and the direction angle detected in the UAM air vehicle direction angle detection module (508) in real time.

The UAM air vehicle energy section database (510) may be configured to previously store stable energy sections, attention energy sections, and warning energy sections of the UAM air vehicle (600) according to predetermined criteria for descent and approach in the descent and approach sections.

The UAM air vehicle energy section discrimination module (511) may be configured to determine in real time the energy section of the UAM air vehicle (600) calculated in real time by the UAM air vehicle energy calculation module (507) referring to the UAM air vehicle energy section database (510).

The UAM air vehicle energy section discrimination module (511) may be configured to determine whether the UAM air vehicle (600) is descending and approaching with the appropriate energy required at each location or altitude in the descent and approach section. In FIG. 3, a stable energy section, an attention energy section, and a warning energy section required at each position or altitude of a descent and approach section are illustrated. Here, in the attention energy section or the warning energy section, it can be seen that the UAM air vehicle (600) descends and approaches with too much propulsion at the location, or descends and approaches in a state of insufficient lifting force.

The UAM air vehicle energy section transmission module (512) may be configured to transmit the energy section determined in real time by the UAM air vehicle energy section discrimination module (511) to the UAM air vehicle (600) in real time.

The UAM air vehicle appropriate altitude/speed calculation module (513) may be configured to inversely calculate the appropriate altitude and appropriate speed from energy to allow the energy of the UAM air vehicle (600) to belong to the stable energy section when the energy section determined in real time by the UAM air vehicle energy section discrimination module (511) is an attention energy section or a warning energy section.

The UAM air vehicle appropriate altitude/speed calculation module (513) may calculate an appropriate altitude and appropriate speed at which the energy of the UAM air vehicle (600) may enter the stable energy section by calculating inversely using the Equation 1. In practice, the UAM air vehicle appropriate altitude/speed calculation module (513) may be configured to find the appropriate speed that can enter the stable energy section while monitoring the actual altitude in the descent and approach section.

The UAM air vehicle appropriate altitude/speed transmission module (514) may be configured to transmit the appropriate altitude and the appropriate speed calculated by the UAM air vehicle appropriate altitude/speed calculation module (513) to the UAM air vehicle (600) in real time.

The UAM air vehicle ground impact value receiving module (515) may be configured to receive a ground impact value generated by the UAM air vehicle (600) upon grounding from the UAM air vehicle (600). Here, it may be determined whether a stable landing is performed based on the magnitude of the ground impact value.

The UAM air vehicle safe ground discrimination module (516) may be configured to analyze the ground process photographed by the safety ground discrimination camera device (400) and the ground shock value received by the UAM air vehicle ground impact value receiving module (515) using an AI algorithm, and to determine whether or not the UAM air vehicle (600) according to a predetermined standard is safely grounded based on the analysis result.

In this case, the ground impact value may be for each ground portion. The UAM air vehicle safe ground discrimination module (516) can determine whether it is grounded in a stable posture by checking the ground impact value and the ground impact time for each ground part. When a specific ground portion is firstly grounded, it may be determined to be an unstable ground. This may be a case in which the landing posture of the UAM air vehicle (600) is not stable due to the high speed during landing.

The UAM air vehicle energy section deep learning module (517) may be configured to perform a deep learning for the stable energy section, the attention energy section, and the warning energy section for the UAM air vehicle (600) using an energy of the real-time calculated UAM air vehicle (600) in the UAM air vehicle energy calculation module (507) at each three-dimensional coordinate of the real-time calculated UAM air vehicle (600) in the UAM air vehicle 3D coordinate calculation module (509), and a safety ground determined in the UAM flying vehicle safety ground determination module (516). This deep learning can be naturally performed for each individual vertiport with different surroundings depending on the model or number of passengers of the UAM air vehicle (600), or individually for each UAM air vehicle (600).

The UAM air vehicle energy section deep learning module (517) may be configured to store a stable energy section, an attention energy section, and a warning energy section by the deep learning in the UAM air vehicle energy section database (510).

The UAM air vehicle posture detection module (518) may be configured to detect posture using the length ratio of both wings of the UAM air vehicle (600) and the up and down direction of both wings in the panorama image generated by the image stitching module (502). Here, if the length ratio of both wings is different, it can be seen that the descending and approaching UAM air vehicle (600) is not facing the vertiport accurately, and if both wings are tilted in the up and down direction, it can be seen that the UAM air vehicle (600) is tilted.

The UAM air vehicle posture guide generation/transmission module (519) may be configured to generate a posture guide for correcting the posture detected by the UAM air vehicle posture detection module (518) and transmit it to the UAM air vehicle (600) in real time.

The UAM air vehicle (600) may be configured to include a UAM air vehicle energy section receiving module (601), a warning output module (602), a control stick vibration module (603), a UAM air vehicle appropriate altitude/speed receiving module (604), a landing guide output module (605), a UAM air vehicle posture guide receiving module (606), a UAM air vehicle posture guide output module (607), a UAM air vehicle automatic landing control module (608), a UAM air vehicle automatic landing driving module (609), a control stick lock-up module (610), a UAM air vehicle ground impact detection sensor (611), and a UAM air vehicle ground impact value transmission module (612).

Hereinafter, a detailed configuration will be described.

The UAM air vehicle energy section receiving module (601) may be configured to receive the energy section of the UAM air vehicle (600) in real time from the UAM air vehicle energy section transmission module (512).

The warning output module (602) may be configured to output a corresponding warning sound through a speaker in real time or a corresponding warning window through a display in real time when the energy section received in real time from the UAM air vehicle energy section receiving module (601) is an attention energy section or a warning energy section.

The control stick vibration module (603) may be configured to apply a vibration to a control stick (10) when the energy section received in real time from the UAM air vehicle energy section receiving module (601) is an attention energy section or a warning energy section.

The UAM air vehicle appropriate altitude/speed receiving module (604) may be configured to receive an appropriate altitude and an appropriate speed in real time from the UAM air vehicle appropriate altitude/speed transmission module (514).

The landing guide output module (605) may be configured to guide the pilot of the UAM air vehicle (600) through a display and speaker at the appropriate altitude and speed received in real time by the UAM air vehicle appropriate altitude/speed receiving module (604), The pilot can control it while checking the appropriate altitude and speed.

The UAM air vehicle posture guide receiving module (606) may be configured to receive the posture guide in real time from the UAM air vehicle posture guide generation/transmission module (519).

The UAM air vehicle posture guide output module (607) may be configured to output the posture guide received in real time from the UAM air vehicle posture guide receiving module (606) through a display or speaker. The pilot may control the plane to take stable posture of the UAM air vehicle (600).

The UAM air vehicle automatic landing control module (608) can be configured to control the automatic landing of the UAM air vehicle (600) using the appropriate altitude and speed received in real time from the UAM air vehicle appropriate altitude/speed receiving module (604) and the posture guide received in real time in the UAM air vehicle posture guide receiving module (606), when the energy section received in real time from the UAM air vehicle energy section receiving module (601) is an attention energy section or a warning energy section.

The UAM air vehicle automatic landing driving module (609) may be configured to drive the automatic landing of the UAM air vehicle (600) by the control of the UAM air vehicle automatic landing control module (608).

The control stick lock-up module (610) may be configured to lock up the control stick when the automatic landing is driven by the UAM air vehicle automatic landing driving module (609).

In this case, when the pilot of the UAM air vehicle (600) touches the control stick (10) and forces the control stick (10) to be driven with some strong force, the control stick lock-up module (610) may be configured to immediately unlock the lock-up of the control stick (10).

The UAM air vehicle ground impact detection sensor (611) may be configured to generate a ground impact value for each ground part by detecting the ground impact of the UAM air vehicle (600) in real time. For example, if there are four ground parts, a ground impact value including each ground time may be generated.

The UAM air vehicle ground impact value transmission module (612) may be configured to transmit the ground impact value generated by the UAM air vehicle ground impact detection sensor (611) in real time.

Although explained with reference to the above embodiment, a person skilled in the art can understand that the present invention may be variously modified and changed within the scope that does not deviate from the idea and area of the present invention described in the following claims.

What is claimed is:

1. A landing guide system, comprising:
a UAM air vehicle; and
a UAM air vehicle landing guide device that guides a landing by analyzing the motion of the UAM air vehicle in a descent and approach section of the UAM air vehicle to a vertiport.

2. The landing guide system according to claim 1, further comprising a remote control terminal for a real-time monitoring of the descent and approach section of the UAM air vehicle through the UAM air vehicle landing guide device.

3. The landing guide system according to claim 1, wherein the UAM air vehicle is configured to output a warning for safe descent and access according to a predetermined standard in the descent and approach section according to the guide of the UAM air vehicle landing guide device.
